(19) United States
(12) Patent Application Publication
(10) Pub. No.: US 2006/0232056 A1
(43) Pub. Date: Oct. 19, 2006

(54) Deflection device for a safety belt

(75) Inventor: Karl Moendel, Schwaebisch Gmuend (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/394,952

(22) Filed: Mar. 31, 2006

(30) Foreign Application Priority Data
Apr. 15, 2005 (DE) 10 2005 017 486.8

(51) Int. Cl. B60R 22/00

(52) U.S. Cl. 280/808; 297/482; 297/483

(57) ABSTRACT

A deflection device for a safety belt comprises a deflection part (10) having a mounting opening (16) and an eye (18) for the safety belt to be passed through. The deflection device further comprises a covering surrounding at least lower and lateral outer edge regions of the deflection part (10). The deflection device further comprises an adapter having a collar section (24), which is inserted into the mounting opening (16) of the deflection part (10), and a boundary section (26), which is inserted into the eye (18). The covering and the adapter are constructed as a plastic part (12) in a single piece. The plastic part (12) is adapted to the installation surrounding of the deflection device.

### TECHNICAL FIELD

The invention relates to a deflection device for a safety belt.

### BACKGROUND OF THE INVENTION

A deflection device, comprising a deflection part having a mounting opening and an eye for the safety belt to be passed through, a covering surrounding at least lower and lateral outer edge regions of the deflection part, and an adapter having a collar section, which is inserted into the mounting opening of the deflection part, and a boundary section which is inserted into the eye, is known from German Patent DE 101 53 062 C1. This deflection device has the advantage that the deflection part can be constructed as a standard component because the vehicle connection and the adaptation to the actual installation surrounding occurs through the design of the adapter or the covering. In the deflection device shown in DE 101 53 062 C1 two half sections of plastic are provided which are pushed laterally onto an edge section of the deflection part and are connected with each other by a plug connection.

German Patent Application DE 103 32 535 A1 shows a similar deflection device. The covering here is constructed as a component in a single piece which surrounds the deflection part.

It is an object of the invention to provide a deflection device which is able to be produced at a more favourable cost and which has the same advantages as the known deflection devices.

### BRIEF SUMMARY OF THE INVENTION

According to the invention, a deflection device for a safety belt comprises a deflection part having a mounting opening and an eye for the safety belt to be passed through, a covering surrounding at least lower and lateral outer edge regions of the deflection part, and an adapter having a collar section, which is inserted into the mounting opening of the deflection part, and a boundary section, which is inserted into the eye. The covering and the adapter are constructed as a plastic part in a single piece, the plastic part being adapted to the installation surrounding of the deflection device. The invention is based on the finding that the different tasks of the possibly vertically adjustable adapter (guiding the belt, fastening the deflection device) and of the covering (shield), which were always undertaken hitherto by separate components, can be fulfilled by a single plastic part. The production of the deflection device according to the invention is very favourably priced, because the number of components is further reduced and only one single injection molding tool is necessary. In addition, the number of installation steps is reduced because only one component has to be fixed to the deflection part. Through the possibility of a flexible design of the plastic part, the deflection device according to the invention is suitable both for concealed and also for visible installation.

The plastic part can be fastened as a finished part to the deflection part by a clip connection or alternatively can be molded directly onto the deflection part.

### BRIEF DESCRIPTION OF THE DRAWINGS

FIG. 1 shows a perspective view of individual parts of a deflection device according to the invention; and

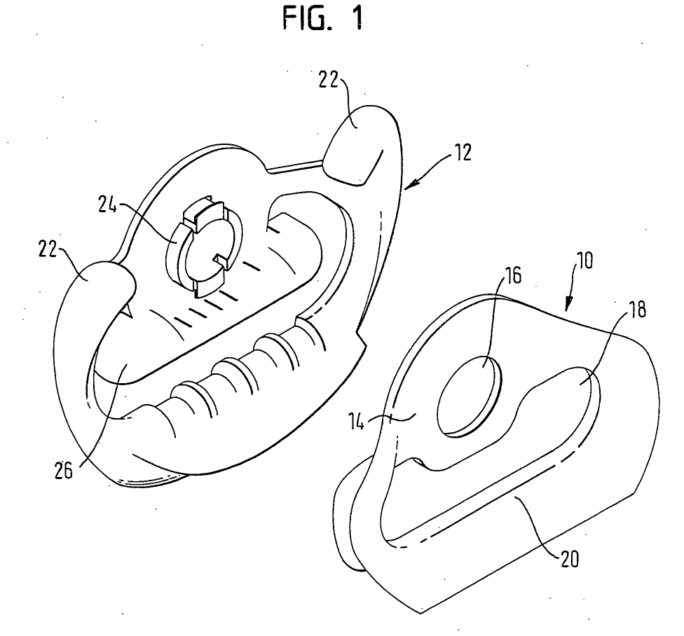

FIG. 2 shows a perspective view of the assembled deflection device.

### DETAILED DESCRIPTION OF THE PREFERRED EMBODIMENT

A deflection device for a safety belt as illustrated in the figures substantially comprises only two components: a deflection part 10 and a plastic part 12. In all embodiments, the deflection part 10 is a standard component independent of the actual installation surrounding (installation situation) of the deflection device. The deflection part 10 has an opening 16 formed in an installation section 14 and an elongated eye 18 through which the safety belt can be guided. The region of the deflection part 10 surrounding the eye 18 on the lower and lateral edges forms a guide section 20 with a running surface for the safety belt.

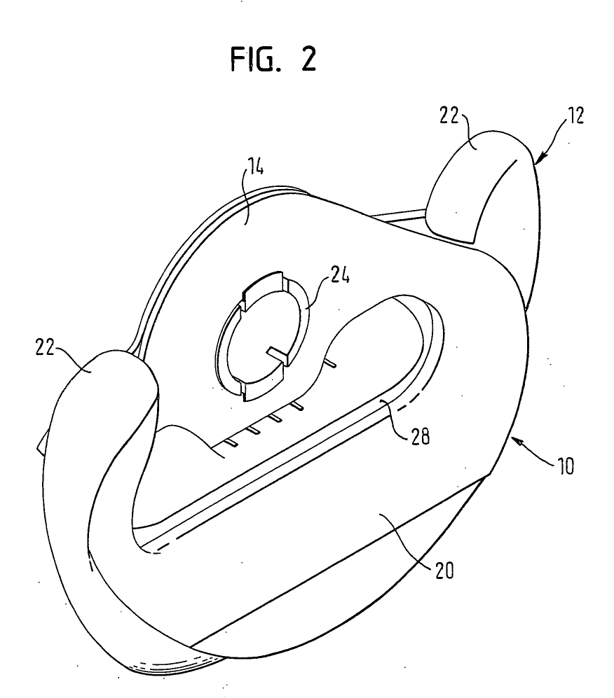

The plastic part 12, which is constructed as a single piece, on the one hand serves to edge the deflection part 10, in particular it surrounds the lower and the lateral outer edge regions of the deflection part 10 (see FIG. 2). The plastic part 12 has two laterally projecting shields 22. The shape of the plastic part 12, in particular that of the shields 22, is adapted to the actual installation surrounding in the vehicle.

However, the plastic part 12 on the other hand also serves as an adapter and has for this a bush-like collar section 24 and a bead-like boundary section 26. In the assembled state of the deflection device, the collar section 24 and the boundary section 26 are inserted into the mounting opening 16 or into the upper region of the belt eye 18 of the deflection part 10. The boundary section 26 of the plastic part 12 delimits the dimensions of the eye 18 in the region lying opposite the belt guide section 20 and thus establishes a defined slot 28 for the safety belt.

The plastic part 12 is designed such that in the installed state it delimits the swivel movement of the deflection device.

The plastic part 12 is an injection-molded piece which is either molded directly onto the deflection part 10 or is clipped on subsequently.

1. A deflection device for a safety belt, the deflection device comprising
a deflection part having a mounting opening and an eye for the safety belt to be passed through,
a covering surrounding at least lower and lateral outer edge regions of the deflection part, and
an adapter having a collar section, which is inserted into the mounting opening of the deflection part, and a boundary section, which is inserted into the eye,
the covering and the adapter being constructed as a plastic part in a single piece, the plastic part being adapted to the installation surrounding of the deflection device.

2. The deflection device according to claim 1, wherein the plastic part is fastened by a clip connection to the deflection part.

3. The deflection device according to claim 1, wherein the plastic part is molded onto the deflection part.

4. The deflection device according to claim 1, wherein the plastic part undertakes the function of a shield.

5. The deflection device according to claim 1, wherein the plastic part is constructed such that in the installed state of the deflection device it delimits the swivel movement of the deflection device.
